(19) United States
(12) Patent Application Publication
(10) Pub. No.: US 2020/0201326 A1
(43) Pub. Date: Jun. 25, 2020

(54) Methods and Systems for Configuring and Instructing Autonomous Vehicles

(71) Applicant: Uber Technologies, Inc., San Francisco, CA (US)

(72) Inventors: Valerie Nina Chadha, San Francisco, CA (US); Rei Chiang, San Francisco, CA (US); Brent Justin Goldman, San Francisco, CA (US); Arvind Srinivasan, Menlo Park, CA (US); Neil Stegall, Pittsburgh, PA (US); Wei Wang, Fremont, CA (US); Ye Yuan, Belmont, CA (US)

(21) Appl. No.: 16/437,227

(22) Filed: Jun. 11, 2019

Related U.S. Application Data
(60) Provisional application No. 62/783,965, filed on Dec. 21, 2018.
(60) Provisional application No. 62/803,048, filed on Feb. 8, 2019.

(51) Int. Cl. G05D 1/00; G05B 13/04; G05D 1/02; G01C 21/36; G06Q 10/06

(52) U.S. Cl. CPC G05D 1/0088; G05B 13/042; G06Q 10/06315; G01C 21/3691; G05D 1/0291; G05D 1/0276

(57) ABSTRACT

The present disclosure is directed to configuring and instructing autonomous vehicles. In particular, one or more computing devices can receive, from a plurality of different autonomous vehicles, data describing travel completed by the plurality of different autonomous vehicles within a geographic area. The computing device(s) can also receive data indicating one or more model parameters for the geographic area. Based at least in part on the data describing the travel and the data indicating the model parameter(s), the computing device(s) can generate one or more models indicating one or more effects of the plurality of different autonomous vehicles on a transportation market for the geographic area. Based at least in part on the model(s), the computing device(s) can generate data indicating instructions for at least one autonomous vehicle of the plurality of different autonomous vehicles and can communicate such data to the at least one autonomous vehicle.

### PRIORITY CLAIM

This application claims priority to: U.S. Patent Application Ser. No. 62/803,048, filed Feb. 8, 2019, and entitled “METHODS AND SYSTEMS FOR CONFIGURING AND INSTRUCTING AUTONOMOUS VEHICLES”; and U.S. Patent Application Ser. No. 62/783,965, filed Dec. 21, 2018, and entitled “METHODS AND SYSTEMS FOR CONFIGURING AND INSTRUCTING AUTONOMOUS VEHICLES”; the disclosures of each of which are incorporated by reference herein in their entirety.

### FIELD

The present disclosure relates generally to autonomous vehicles. More particularly, the present disclosure relates to configuring and instructing autonomous vehicles.

### BACKGROUND

An autonomous vehicle is a vehicle that is capable of sensing its environment and navigating with minimal or no human input. In particular, an autonomous vehicle can observe its surrounding environment using a variety of sensors and identify an appropriate path through such surrounding environment.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can include receiving, by one or more computing devices and from a plurality of different autonomous vehicles, data describing travel completed by the plurality of different autonomous vehicles within a geographic area. The method can also include receiving, by the computing device(s), data indicating one or more model parameters for the geographic area. The method can further include generating, by the computing device(s) and based at least in part on the data describing the travel and the data indicating the model parameter(s), one or more models indicating one or more effects of the plurality of different autonomous vehicles on a transportation market for the geographic area. The method can further include generating, by the computing device(s) and based at least in part on the model(s), data indicating instructions for at least one autonomous vehicle of the plurality of different autonomous vehicles. The method can further include communicating, by the computing device(s) and to the at least one autonomous vehicle, the data indicating the instructions for the at least one autonomous vehicle.

Another example aspect of the present disclosure is directed to a system. The system can include one or more processors and a memory storing instructions that when executed by the processor(s) cause the system to perform operations. The operations can include receiving, from a plurality of different autonomous vehicles, data describing travel completed by the plurality of different autonomous vehicles within a geographic area. The operations can also include generating, based at least in part on the data describing the travel completed by the plurality of different autonomous vehicles and data describing travel completed by a plurality of different human-driven vehicles within the geographic area, one or more models indicating one or more effects of the plurality of different autonomous vehicles on a transportation market for the geographic area. The operations can further include generating, based at least in part on the model(s), data describing a report indicating one or more relationships between functions, within the geographic area, of the plurality of different autonomous vehicles and the plurality of different human-driven vehicles. The operations can further include communicating, to a computing device, the data describing the report indicating the relationship(s).

A further example aspect of the present disclosure is directed to one or more non-transitory computer-readable media comprising instructions that when executed by one or more computing devices cause the computing device(s) to perform operations. The operations can include receiving data describing travel completed by a fleet of associated vehicles within a geographic area. The operations can also include generating, based at least in part on the data describing the travel, one or more models indicating one or more effects of a plurality of different autonomous vehicles on a transportation market for the geographic area. The operations can further include determining, based at least in part on the model(s), one or more locations in the geographic area for performing one or more functions associated with the plurality of different autonomous vehicles. The operations can further include generating, based at least in part on the model(s), data describing a report identifying the location(s) with respect to the function(s) associated with the plurality of different autonomous vehicles. The operations can further include communicating, to a computing device, the data describing the report identifying the location(s).

The autonomous vehicle technology described herein can help improve the safety of passengers of an autonomous vehicle, improve the safety of the surroundings of the autonomous vehicle, improve the experience of the rider and/or operator of the autonomous vehicle, as well as provide other improvements as described herein. Moreover, the autonomous vehicle technology of the present disclosure can help improve the ability of an autonomous vehicle to effectively provide vehicle services to others and support the various members of the community in which the autonomous vehicle is operating, including persons with reduced mobility and/or persons that are underserved by other transportation options. Additionally, the autonomous vehicle of the present disclosure may reduce traffic congestion in communities as well as provide alternate forms of transportation that may provide environmental benefits.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example autonomous vehicle according to example embodiments of the present disclosure;

FIG. 2 depicts an example computing environment according to example embodiments of the present disclosure;

FIGS. 3A and 3B depict an example event sequence according to example embodiments of the present disclosure;

FIGS. 4 and 5 depict example system architectures according to example embodiments of the present disclosure;

FIG. 6 depicts an example simulation flow according to example embodiments of the present disclosure;

FIGS. 7 and 8 depict example states according to example embodiments of the present disclosure;

FIGS. 9 and 10 depict example functional forms according to example embodiments of the present disclosure;

FIGS. 11-13 depict example methods according to example embodiments of the present disclosure; and

FIG. 14 depicts an example computing system according to example embodiments of the present disclosure.

### DETAILED DESCRIPTION

Example aspects of the present disclosure are directed to configuring and instructing autonomous vehicles. In particular, an entity (e.g., company, organization, government, and/or the like) can provide, operate, maintain, and/or the like a fleet of associated vehicles, which can include, for example, one or more autonomous vehicles, human-driven vehicles, and/or the like. Such vehicle(s), a portion of such vehicle(s), and/or the like can operate within a given geographic area, for example, completing commissioned travel, non-commissioned travel between such commissioned travel, and/or the like. In accordance with aspects of the disclosure, a computing system (e.g., one or more computing devices, and/or the like) can receive (e.g., from the vehicle(s), from a computing system associated with the vehicle(s), and/or the like) data describing travel completed by the vehicle(s) within the geographic area and can generate, based at least in part on such data, one or more models indicating one or more effects of one or more autonomous vehicles on a transportation market for the geographic area. As will be described in greater detail, based at least in part on such model(s), the computing system can generate instructions for one or more of such autonomous vehicle(s), determine a configuration of one or more of such autonomous vehicle(s), determine one or more locations within the geographic area for performing one or more functions with respect to one or more of such autonomous vehicle(s), and/or the like.

In some embodiments, the computing system can generate the model(s) based at least in part on one or more parameters. For example, the computing system can receive data indicating such parameter(s) (e.g., via user input, and/or the like). The data indicating the parameter(s) can indicate, for example, one or more weather conditions for the geographic area (e.g., a metric of temperature, precipitation probability, precipitation intensity, precipitation type, cloud cover, dew point, humidity, visibility, wind speed, wind bearing, sun angle, ultraviolet (UV) index, and/or the like), one or more capabilities of one or more of the autonomous vehicle(s) (e.g., passenger capacity, operating requirements, performance constraints, and/or the like), a date, time, time of day, day of week, week of month, month of year, and/or the like.

In some embodiments, for any given time, one or more of the vehicle(s) (e.g., the autonomous vehicle(s), human-driven vehicle(s), and/or the like) can be associated with one or more different vehicle states. For example, such state(s) can include a state characterized by availability within the geographic area, a state characterized by commissioned movement within the geographic area, a state characterized by non-commissioned movement within the geographic area, a state characterized by planning commissioned travel, a state characterized by transitioning amongst one or more of the other states, and/or the like.

In some of such embodiments, generating the model(s) can include generating a different and distinct model for each of such vehicle state(s). For example, a model for the state characterized by availability within the geographic area could predict the number of vehicles operating within, entering, leaving, and/or the like the transportation market for the geographic area. Similarly, a model for the state characterized by commissioned movement within the geographic area can predict time spent on commissioned travel, routes utilized by such travel, and/or the like. While a model for the state characterized by non-commissioned movement within the geographic area can predict time utilized, distance traveled, and/or the like traveling from the conclusion of an instance of commissioned travel to initiation of a new instance of commissioned travel, and/or the like. A model for the state characterized by planning commissioned travel can predict the availability of vehicles for commissioned travel, and/or the like. And a model for the state characterized by transitioning amongst one or more of the other states can predict whether a vehicle will transition to a different state, what such state will be, when such transition will occur, and/or the like.

In some embodiments, based at least in part on the model(s), the computing system can execute one or more simulations of one or more operations, functions, and/or the like, within the geographic area, of one or more of the vehicle(s). For example, such simulation(s) can simulate dynamics of the transportation market for the geographic area (e.g., in light of the model parameter(s), and/or the like). In some embodiments, for each time interval of a plurality of different time intervals within a time period for which the simulation(s) are configured to simulate the operation(s), function(s), and/or the like of the vehicle(s), the computing system can execute, for each vehicle of the vehicle(s) and each state of the different vehicle state(s), the model for the state in association with the vehicle for the time interval.

In some embodiments, the computing system can interface (e.g., directly, indirectly, and/or the like) with one or more other systems for planning, modeling, simulating, and/or the like one or more aspects of the geographic area, the transportation market for the geographic area, and/or the like. For example, such systems can include functionality for identifying locations within the geographic area for loading and/or unloading passengers, determining possible routes navigable by autonomous vehicles, estimating the available size of the transportation market for the geographic area, one or more aspects thereof, and/or the like, estimating the size of a fleet of autonomous vehicles for servicing one or more aspects of such transportation market, and/or the like.

In some embodiments, the computing system can receive data indicating availability of one or more autonomous vehicles configurable to operate within the geographic area. For example, the fleet of associated vehicles can be associated with a particular provider of autonomous vehicles, and the computing system can receive data indicating availability of one or more autonomous vehicles associated with a different and distinct (e.g., third-party, and/or the like) provider of autonomous vehicles configurable to operate within the geographic area. In some of such embodiments, the computing system can generate the model(s) based at least in part on the data indicating such availability.

In some embodiments, the computing system can receive data indicating availability of a non-automobile mode of transit (e.g., mass transit, rail transit, bicycles, scooters, and/or the like) configurable to operate within the geographic area. In some of such embodiments, the computing system can generate the model(s) based at least in part on the data indicating such availability.

In some embodiments, the computing system can provide (e.g., to a computing system associated with the different and distinct provider of autonomous vehicles, a provider of the non-automobile mode of transit, and/or the like) an application programming interface (API). In some of such embodiments, the data indicating the availability of the autonomous vehicle(s), non-automobile mode of transit, and/or the like configurable to operate within the geographic area can be received (e.g., from the computing system associated with the different and distinct provider of autonomous vehicles, the provider of the non-automobile mode of transit, and/or the like) via such API, and/or the like.

In some embodiments, the simulation(s) can flow amongst various constituent components, including, for example, an input layer, functionality for spawning vehicle-simulation agents, determining, identifying, and/or the like travel for a given interval of the simulation, simulating one or more planning decisions, travel, and/or the like, and based at least in part thereon, generating one or more metrics about the geographic area, the transportation market for the geographic area, and/or the like. For example, such an input layer could include receiving, determining, generating, and/or the like data indicating a date or date range for the simulation, a length of time (e.g., number of days, and/or the like) to be simulated, demand (e.g., describing various travel requests, and/or the like) for the simulation (e.g., based at least in part on the model(s), and/or the like), supply (e.g., availability of various vehicle types, configurations, and/or the like) for the simulation (e.g., based at least in part on the model(s), and/or the like), and/or supply dynamics (e.g., non-commissioned-travel behavior of various vehicle types, configurations, and/or the like) for the simulation (e.g., based at least in part on the model(s), and/or the like).

In some of such embodiments, such supply dynamics can be based at least in part on one or more different models. In some embodiments, such model(s) can include one or more demand-driven models, for example, under which vehicles relocate to areas with historic, anticipated, and/or the like demand when not commissioned, and/or the like. In some embodiments, such demand-driven model(s) can, for example, assign certain vehicles to remain stationary (e.g., based at least in part on a predetermined probability, and/or the like), while relocating other vehicles to areas determined based at least in part on a function of demand within the areas, distance to the areas from such vehicles' current locations, and/or the like. In some of such embodiments, the system can periodically re-determine whether a vehicle should remain stationary or relocate based on passage of a given amount of time without the vehicle being assigned commissioned travel, and/or the like. Additionally or alternatively, the model(s) can include one or more stationary models, for example, under which vehicles remain stationary when not commissioned, and/or the like. In some embodiments, such stationary model(s) can, for example, be utilized as default model(s), and/or the like. Additionally or alternatively, the model(s) can include one or more randomized models, for example, under which a random determination is made as to whether a vehicle remains stationary or relocates when not commissioned, and/or the like. In some embodiments, such randomized model(s) can, for example, assign certain vehicles to remain stationary (e.g., based at least in part on a predetermined probability, and/or the like), while relocating other vehicles to certain areas (e.g., the center of a randomly selected region from one or more identified regions surrounding a vehicle's current location, and/or the like), periodically re-determine whether a vehicle should remain stationary or relocate based on passage of a given amount of time without the vehicle being assigned commissioned travel, and/or the like.

In some embodiments, the vehicle-simulation agents can function based at least in part on a discrete set of states and transitions amongst such states (e.g., a finite-state machine, and/or the like). Such agents can be configured to simulate various vehicle types, configurations, and/or the like, for example, autonomous vehicles, human-driven vehicles, and/or the like. For example, such agents can be associated with one or more shifts (e.g., based at least in part on historical logon/logoff times of its driver(s), and/or the like), can be spawned within the simulation at its logon location, re-spawned at its re-login location(s), track its spawn location(s), the time to its next shift, the time to the end of the current shift, and/or the like, and/or be configured to operate in accordance with certain parameters (e.g., complete commissioned travel, move or remain stationary between commissioned travel, govern travel in accordance with one or more geographic, speed, or performance constraints, and/or the like).

In some embodiments, based at least in part on the model(s), simulation(s), and/or the like, the computing system can determine a configuration for the fleet (e.g., how many of various particular vehicle types, capabilities, configurations, and/or the like to utilize in the geographic area at a particular time, and/or the like), one or more locations within the geographic area for performing one or more operations, functions, and/or the like associated with one or more of the autonomous vehicle(s), and/or the like. For example, such location(s) can include one or more locations for loading and/or unloading passengers of such vehicle(s), storing, refueling, recharging, or maintaining such vehicle(s), locating infrastructure supporting one or more non-automobile modes of transit (e.g., for transitioning between autonomous vehicles and such other transit modes, and/or the like) associated with such vehicle(s), and/or the like.

In some embodiments, the fleet configuration can be optimized, the location(s) can be determined to optimize the operation(s), function(s), and/or the like based at least in part on data indicated by the model(s), simulation(s), and/or the like. For example, such data can indicate number of units of travel traveled (e.g., measured in time, distance, and/or the like), cost incurred per unit of travel, revenue generated per unit of travel, profit generated per unit of travel, amount of commissioned travel, amount of non-commissioned travel, amount of autonomous-vehicle travel, amount of human-driven-vehicle travel, amount of non-automobile travel, amount of travel by passengers from origin-request locations to vehicle-loading locations, amount of travel by passengers from vehicle-unloading locations to passenger-specified destinations, time waited by passengers for vehicles to arrive, and/or the like.

As previously indicated, in some embodiments, based at least in part on the model(s), simulation(s), and/or the like, the computing system can generate instructions for one or more of the autonomous vehicle(s). For example, such instructions can direct such vehicle(s) to travel to a particular location in order to initiate new commissioned travel, station themselves at a particular location to await further instructions (e.g., associated with new commissioned travel, and/or the like), travel to a particular location for maintenance, refueling, recharging, and/or the like, relocate to a different geographic area (e.g., with higher demand, a less saturated transit supply, more favorable weather conditions, and/or the like).

Additionally or alternatively, based at least in part on the model(s), simulation(s), and/or the like, the computing system can generate data describing a report and can communicate such data to a computing device (e.g., for subsequent analysis, reconfiguration of the fleet, refinement of operational designs, logistics, and/or the like). For example, such a report can indicate one or more relationships (e.g., effects, dynamics, and/or the like) between operations, functions, and/or the like, within the geographic area, of one or more autonomous vehicles included in the fleet, one or more human-driven vehicles included within the fleet, and/or the like. Additionally or alternatively, such a report can identify one or more of the determined location(s) with respect to the function(s) associated with the autonomous vehicle(s), and/or the like.

Various means can be configured to perform the methods and processes described herein. For example, a computing system can include model-generation unit(s), simulation-execution unit(s), report-generation unit(s), data-communication unit(s), and/or other means for performing the operations and functions described herein. In some implementations, one or more of the units can be implemented separately. In some implementations, one or more units can be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry, for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means can be configured to generate the model(s), execute the simulation(s), determine the configuration(s), location(s), and/or the like, generate and/or communicate the data describing the report(s), and/or the like. In some implementations, the means can be configured to obtain (e.g., via an accessible memory) data, information, and/or the like (e.g., regarding the weather conditions, availability of vehicles, non-automobile modes of transportation, and/or the like) associated with the geographic area. A data-obtaining unit is one example of a means for obtaining such data as described herein.

The technology described herein can provide a number of technical effects and benefits. For example, the technology described herein can instruct, configure, and/or the like one or more autonomous vehicles based at least in part on modeled, simulated, predicted, anticipated, and/or the like conditions. Accordingly, the technology described here can allocate, configure, and/or the like such vehicle(s), their associated infrastructure, and/or the like in a manner that reduces their resource consumption, optimizes their utilization, performance, and/or the like.

With reference now to the figures, example embodiments of the present disclosure will be discussed in further detail.

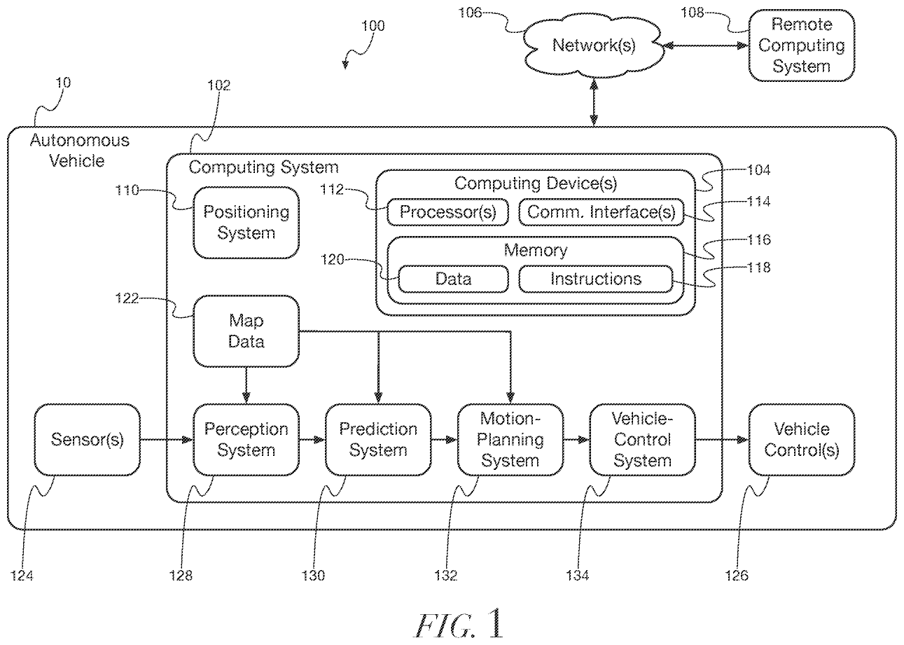

FIG. 1 depicts an example autonomous vehicle according to example embodiments of the present disclosure.

Referring to FIG. 1, environment 100 can include autonomous vehicle 10, one or more networks 106, and computing system 108.

Autonomous vehicle 10 can be capable of sensing its environment, navigating its environment with minimal or no human input, and/or the like. Autonomous vehicle 10 can be a ground-based autonomous vehicle (e.g., car, truck, bus, and/or the like), an air-based autonomous vehicle (e.g., airplane, drone, helicopter, bike, scooter, light electric vehicle, and/or the like), and/or other type of vehicle (e.g., watercraft, and/or the like). Autonomous vehicle 10 can include one or more sensors 124, computing system 102, and one or more vehicle controls 126. Computing system 102 can assist in controlling autonomous vehicle 10. For example, computing system 102 can receive data generated by sensor(s) 124, attempt to comprehend an environment surrounding autonomous vehicle 10 by performing various processing techniques on the data generated by sensor(s) 124, generate, determine, select, and/or the like a motion plan for navigating autonomous vehicle 10 through, within, and/or the like such surrounding environment, and/or the like. Computing system 102 can interface with vehicle control(s) 126 to operate autonomous vehicle 10 (e.g., in accordance with the motion plan, and/or the like).

Computing system 102 can include one or more computing devices 104. Computing device(s) 104 can include circuitry configured to perform one or more operations, functions, and/or the like described herein. For example, computing device(s) 104 can include one or more processor(s) 112, one or more communication interfaces 114, and memory 116 (e.g., one or more hardware components for storing executable instructions, data, and/or the like). Communication interface(s) 114 can enable computing device(s) 104 to communicate with one another, and/or can enable autonomous vehicle 10 (e.g., computing system 102, computing device(s) 104, and/or the like) to communicate with one or more computing systems, computing devices, and/or the like distinct from autonomous vehicle 10 (e.g., computing system 108, and/or the like). Memory 116 can include (e.g., store, and/or the like) instructions 118 and data 120. When executed by processor(s) 112, instructions 118 can cause autonomous vehicle 10 (e.g., computing system 102, computing device(s) 104, and/or the like) to perform one or more operations, functions, and/or the like described herein. Data 120 can include, represent, and/or the like information associated with such operations, functions, and/or the like, data generated by sensor(s) 124, and/or the like.

Computing system 102 can be physically located onboard autonomous vehicle 10, and computing system 108 can be distinct and/or remotely located from autonomous vehicle 10. Network(s) 106 (e.g., wired networks, wireless networks, and/or the like) can interface autonomous vehicle 10 (e.g., computing system 102, computing device(s) 104, and/or the like) with computing system 108, which can include one or more computing devices analogous to computing device(s) 104, one or more components (e.g., memory, processors, communication interfaces, and/or the like) analogous to those of computing device(s) 104, and/or the like. Irrespective of attribution described or implied herein, unless explicitly indicated otherwise, the operations, functions, and/or the like described herein can be performed by computing system(s) 102 and/or 108 (e.g., by computing system 102, by computing system 108, by a combination of computing systems 102 and 108, and/or the like).

Computing system 102 can include positioning system 110, which can include one or more devices, circuitry, and/or the like for analyzing, approximating, determining, and/or the like one or more geographic positions of autonomous vehicle 10. For example, positioning system 110 can analyze, approximate, determine, and/or the like such position(s) using one or more inertial sensors, triangulations and/or proximities to network components (e.g., cellular towers, WiFi access points, and/or the like), satellite positioning systems, network addresses, and/or the like. Computing system 102 can include perception system 128, prediction system 130, and motion-planning system 132, which can cooperate to perceive a dynamic environment surrounding autonomous vehicle 10, generate, determine, select, and/or the like a motion plan for autonomous vehicle 10, and/or the like.

Perception system 128 can receive data from sensor(s) 124, which can be coupled to or otherwise included within autonomous vehicle 10. Sensor(s) 124 can include, for example, one or more cameras (e.g., visible spectrum cameras, infrared cameras, and/or the like), light detection and ranging (LIDAR) systems, radio detection and ranging (RADAR) systems, and/or the like. Sensor(s) 124 can generate data including information that describes one or more locations, velocities, vectors, and/or the like of objects in the environment surrounding autonomous vehicle 10. For example, a LIDAR system can generate data indicating the relative location (e.g., in three-dimensional space relative to the LIDAR system, and/or the like) of a number of points corresponding to objects that have reflected a ranging laser of the LIDAR system. Such a LIDAR system can, for example, measure distances by measuring the interference between outgoing and incoming light waves, measuring the time of flight (TOF) it takes a short laser pulse to travel from a sensor to an object and back, calculating the distance based at least in part on the TOF with respect to the known speed of light, based at least in part on a phase-shift with known wavelength, and/or the like. As another example, a RADAR system can generate data indicating one or more relative locations (e.g., in three-dimensional space relative to the RADAR system, and/or the like) of a number of points corresponding to objects that have reflected a ranging radio wave of the RADAR system. For example, radio waves (e.g., pulsed, continuous, and/or the like) transmitted by such a RADAR system can reflect off an object and return to a receiver of the RADAR system, generating data from which information about the object's location, speed, and/or the like can be determined. As another example, for one or more cameras, various processing techniques, for example, range-imaging techniques (e.g., structure from motion, structured light, stereo triangulation, and/or the like) can be performed to identify one or more locations (e.g., in three-dimensional space relative to the camera(s), and/or the like) of a number of points corresponding to objects depicted in imagery captured by the camera(s).

Perception system 128 can retrieve, obtain, and/or the like map data 122, which can provide information about an environment surrounding autonomous vehicle 10. For example, map data 122 can provide information regarding: the identity and location of different travelways (e.g., roadways, and/or the like), road segments, buildings, other static items or objects (e.g., lampposts, crosswalks, curbing, and/or the like); the location and directions of traffic lanes (e.g., the location and/or direction of a parking lane, turning lane, bicycle lane, and/or the like); traffic-control data (e.g., the location and/or instructions of signage, traffic lights, other traffic-control devices, and/or the like); other map data providing information that can assist computing system 102 in comprehending, perceiving, and/or the like an environment surrounding autonomous vehicle 10, its relationship thereto, and/or the like.

Perception system 128 can (e.g., based at least in part on data received from sensor(s) 124, map data 122, and/or the like) identify one or more objects proximate to autonomous vehicle 10 and determine, for each of such object(s), state data describing a current state of the object, for example, an estimate of the object's: size/footprint (e.g., as represented by a bounding shape such as a polygon, polyhedron, and/or the like); class (e.g., vehicle, pedestrian, bicycle, and/or the like); current location (also referred to as position), speed (also referred to as velocity), acceleration, heading, orientation, yaw rate; and/or the like. In some embodiments, perception system 128 can determine such state data for each object over a number of iterations, for example, updating, as part of each iteration, the state data for each object. Accordingly, perception system 128 can detect, track, and/or the like such object(s) over time.

Prediction system 130 can receive state data from perception system 128 and can predict (e.g., based at least in part on such state data, and/or the like) one or more future locations for each object. For example, prediction system 130 can predict where each object will be located within the next five seconds, ten seconds, twenty seconds, and/or the like. As one example, an object can be predicted to adhere to its current trajectory according to its current speed. Additionally or alternatively, other prediction techniques, modeling, and/or the like can be used.

Motion-planning system 132 can generate, determine, select, and/or the like a motion plan for autonomous vehicle 10, for example, based at least in part on state data of object(s) provided by perception system 128, predicted future location(s) of object(s) provided by prediction system 130, and/or the like. For example, utilizing information about current location(s) of object(s), predicted future location(s) of object(s), and/or the like, motion-planning system 132 can generate, determine, select, and/or the like a motion plan for autonomous vehicle 10 that it determines (e.g., based at least in part on one or more operation parameters, and/or the like) best navigates autonomous vehicle 10 relative to the object(s). Motion-planning system 132 can provide the motion plan to vehicle-control system 134, which can directly and/or indirectly control autonomous vehicle 10 via vehicle control(s) 126 (e.g., one or more actuators, devices, and/or the like that control gas, power flow, steering, braking, and/or the like) in accordance with the motion plan.

Perception system 128, prediction system 130, motion-planning system 132, and/or vehicle-control system 134 can include logic utilized to provide functionality described herein. Perception system 128, prediction system 130, motion-planning system 132, and/or vehicle-control system 134 can be implemented in hardware (e.g., circuitry, and/or the like), firmware, software configured to control one or more processors, one or more combinations thereof, and/or the like. For example, instructions 118, when executed by processor(s) 112, can cause autonomous vehicle 10 (e.g., computing system 102, computing device(s) 104, and/or the like) to implement functionality of perception system 128, prediction system 130, motion-planning system 132, and/or vehicle-control system 134 described herein.

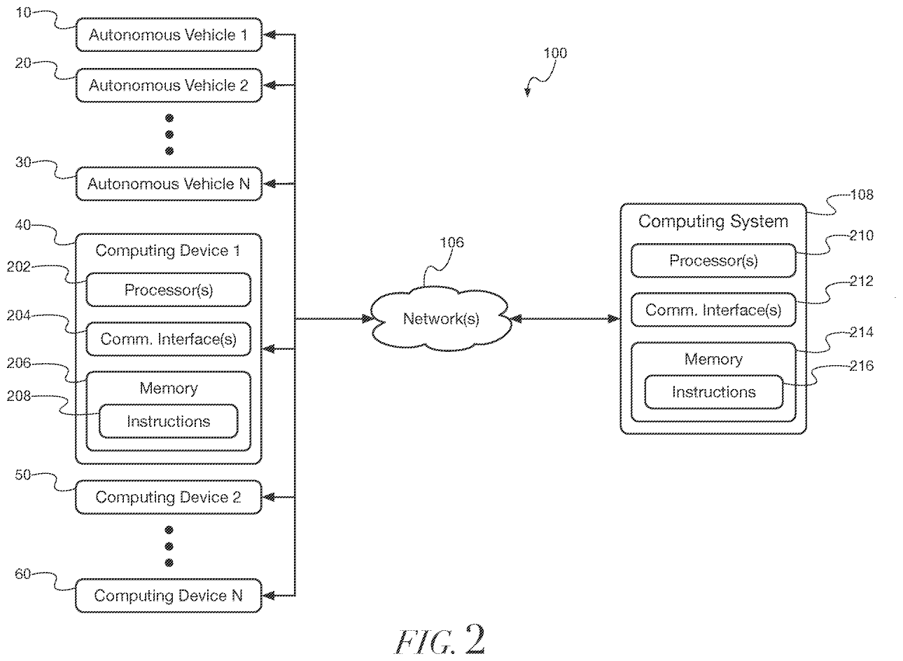

FIG. 2 depicts an example computing environment according to example embodiments of the present disclosure.

Referring to FIG. 2, as previously indicated, environment 100 can include autonomous vehicle 10, network(s) 106, and computing system 108. Environment 100 can also include autonomous vehicle(s) 20 and/or 30, and/or computing device(s) 40, 50, and/or 60.

Autonomous vehicle(s) 20 and/or 30 can include one or more components analogous to those described above with respect to autonomous vehicle 10, and/or the like.

Computing device 40 can include can include circuitry configured to perform one or more operations, functions, and/or the like described herein. For example, computing device 40 can include one or more processor(s) 202, one or more communication interfaces 204, and memory 206 (e.g., one or more hardware components for storing executable instructions, data, and/or the like). Communication interface(s) 204 can enable computing device 40 to communicate with autonomous vehicle 10 (e.g., computing system 102, computing device(s) 104, and/or the like), autonomous vehicle(s) 20 and/or 30, computing device(s) 50, and/or 60, computing system 108, and/or the like. Memory 206 can include (e.g., store, and/or the like) instructions 208, which, when executed by processor(s) 202, can cause computing device 40 to perform one or more operations, functions, and/or the like described herein.

Computing device(s) 50 and/or 60 can include one or more components analogous to those described above with respect to computing device 40, and/or the like.

Computing system 108 can include one or more computing devices, which can include circuitry configured to perform one or more operations, functions, and/or the like described herein. For example, computing system 108 can include one or more processor(s) 210, one or more communication interfaces 212, and memory 214 (e.g., one or more hardware components for storing executable instructions, data, and/or the like). Communication interface(s) 212 can enable computing system 108 to communicate with autonomous vehicle 10 (e.g., computing system 102, computing device(s) 104, and/or the like), autonomous vehicle(s) 20 and/or 30, computing device(s) 40, 50, and/or 60, and/or the like. Memory 214 can include (e.g., store, and/or the like) instructions 216, which, when executed by processor(s) 210, can cause computing system 108 (e.g., one or more computing devices included therein, and/or the like) to perform one or more operations, functions, and/or the like described herein.

It will be appreciated that irrespective of attribution described or implied herein, unless explicitly indicated otherwise, the operations, functions, and/or the like described herein can be performed by autonomous vehicle(s) 10 (e.g., computing system 102, computing device(s) 104, and/or the like), 20, and/or 30, computing device(s) 40, 50, and/or 60, and/or computing system 108 (e.g., by autonomous vehicle(s) 10, 20, and/or 30, by computing device(s) 40, 50, and/or 60, by computing system 108, by a combination of autonomous vehicle(s) 10, 20, and/or 30, computing device(s) 40, 50, and/or 60, computing system 108, and/or the like).

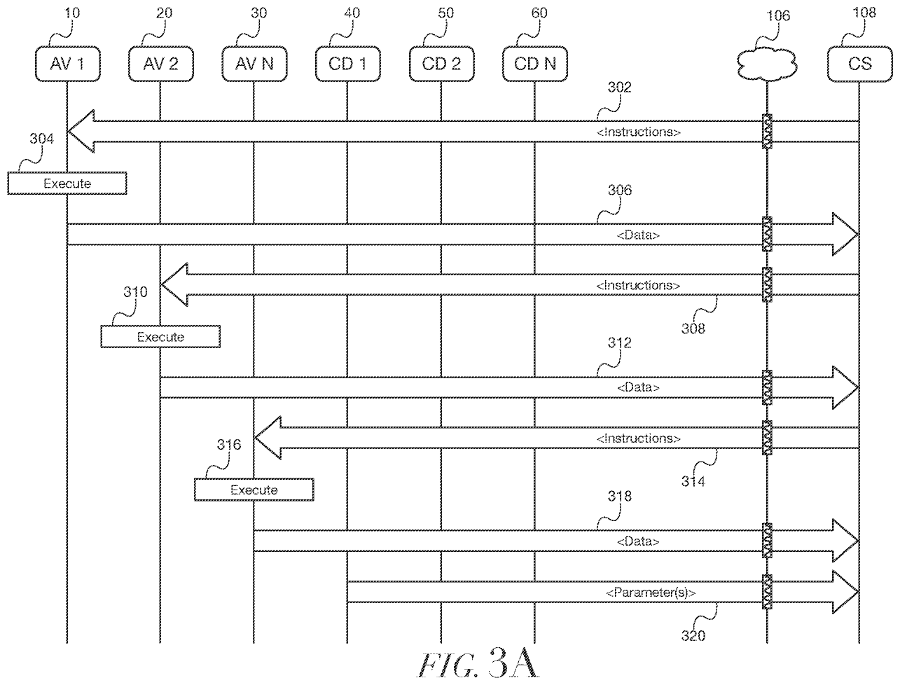

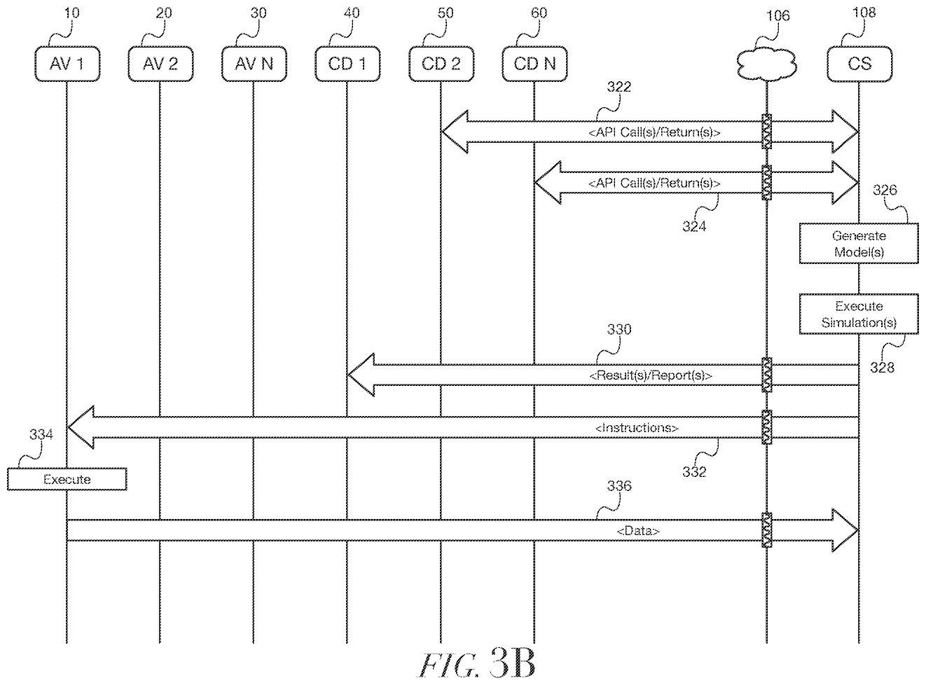

FIGS. 3A and 3B depict an example event sequence according to example embodiments of the present disclosure.

Referring to FIG. 3A, at (302), computing system 108 can generate data indicating instructions (e.g., describing one or more aspects of a travel route including commissioned travel, and/or the like) for autonomous vehicle 10 and can communicate (e.g., via network(s) 106, as indicated by the pattern-filled box over the line extending downward from network(s) 106, and/or the like) such data to autonomous vehicle 10, which can receive the data and, at (304), can execute the instructions (e.g., autonomously navigate one or more portions of the travel route, and/or the like). At (306), autonomous vehicle 10 can generate data describing travel completed by autonomous vehicle 10 (e.g., the portion(s) of the travel route, and/or the like) and can communicate such data to computing system 108, which can receive the data.

Similarly, at (308), computing system 108 can generate data indicating instructions (e.g., describing one or more aspects of a travel route including commissioned travel, and/or the like) for autonomous vehicle 20 and can communicate such data to autonomous vehicle 20, which can receive the data and, at (310), can execute the instructions (e.g., autonomously navigate one or more portions of the travel route, and/or the like) and, at (312), can generate data describing travel completed by autonomous vehicle 20 (e.g., the portion(s) of the travel route, and/or the like) and can communicate such data to computing system 108, which can receive the data; and at (314), computing system 108 can generate data indicating instructions (e.g., describing one or more aspects of a travel route including commissioned travel, and/or the like) for autonomous vehicle 30 and can communicate such data to autonomous vehicle 30, which can receive the data and, at (316), can execute the instructions (e.g., autonomously navigate one or more portions of the travel route, and/or the like) and, at (312), can generate data describing travel completed by autonomous vehicle 30 (e.g., the portion(s) of the travel route, and/or the like) and can communicate such data to computing system 108, which can receive the data.

For example, an entity (e.g., company, organization, government, and/or the like) can provide, operate, maintain, and/or the like a fleet of associated vehicles, which can include, for example, autonomous vehicle(s) 10, 20, and/or 30, one or more human-driven vehicles, and/or the like. Such vehicle(s), a portion of such vehicle(s), and/or the like can operate within a given geographic area, for example, completing commissioned travel, non-commissioned travel between such commissioned travel, and/or the like; and in accordance with aspects of the disclosure, computing system 108 can receive (e.g., from the vehicle(s), from a computing system associated with the vehicle(s), and/or the like) data describing travel completed by the vehicle(s) within the geographic area.

At (320), computing device 40 can generate (e.g., based at least in part on user input, and/or the like) data indicating one or more parameters based at least in part on which one or more models indicating one or more effects of autonomous vehicle(s) 10, 20, and/or 30 on a transportation market for the geographic area can be generated, and computing device 40 can communicate such data to computing system 108, which can receive the data. The data indicating the parameter(s) can indicate, for example, one or more weather conditions for the geographic area (e.g., a metric of temperature, precipitation probability, precipitation intensity, precipitation type, cloud cover, dew point, humidity, visibility, wind speed, wind bearing, sun angle, ultraviolet (UV) index, and/or the like), one or more capabilities of autonomous vehicle(s) 10, 20, and/or 30 (e.g., passenger capacity, operating requirements, performance constraints, and/or the like), a date, time, time of day, day of week, week of month, month of year, and/or the like.

Referring to FIG. 3B, at (322), computing device 50 can generate data indicating availability of one or more autonomous vehicles configurable to operate within the geographic area and can communicate such data to computing system 108, which can receive the data. For example, the fleet of associated vehicles (e.g., autonomous vehicle(s) 10, 20, and/or 30) can be associated with a particular provider of autonomous vehicles, and computing system 108 can receive data indicating availability of one or more autonomous vehicles associated with a different and distinct (e.g., third-party, and/or the like) provider of autonomous vehicles configurable to operate within the geographic area. In some embodiments, computing system 108 can provide, for example, to a computing system associated with the different and distinct provider of autonomous vehicles (e.g., computing device 50, and/or the like) an application programming interface (API). In some of such embodiments, the data indicating the availability of the autonomous vehicle(s), and/or the like configurable to operate within the geographic area can be received (e.g., from computing device 50, and/or the like) via such API, and/or the like.

At (324), computing device 60 can generate data indicating availability of a non-automobile mode of transit (e.g., mass transit, rail transit, bicycles, scooters, and/or the like) configurable to operate within the geographic area and can communicate such data to computing system 108, which can receive the data. In some embodiments, computing system 108 can provide, for example, to a computing system associated with a provider of the non-automobile mode of transit (e.g., computing device 60, and/or the like) an API. In some of such embodiments, the data indicating the availability of the non-automobile mode of transit, and/or the like configurable to operate within the geographic area can be received (e.g., from computing device 60, and/or the like) via such API, and/or the like.

At (326), based at least in part on the data received at (306), (312), (318), (320), (322), and/or (324), computing system 108 can generate one or more models indicating one or more effects of autonomous vehicle(s) 10, 20, and/or 30 on the transportation market for the geographic area. At (328), based at least in part on the model(s), computing system 108 can execute one or more simulations of one or more operations, functions, and/or the like, within the geographic area, of one or more of autonomous vehicle(s) 10, 20, and/or 30. For example, such simulation(s) can simulate dynamics of the transportation market for the geographic area (e.g., in light of the model parameter(s), and/or the like).

In some embodiments, based at least in part on the model(s), simulation(s), and/or the like, computing system 108 can determine a configuration for the fleet (e.g., how many of various particular vehicle types, capabilities, configurations, and/or the like to utilize in the geographic area at a particular time, and/or the like), one or more locations within the geographic area for performing one or more operations, functions, and/or the like associated with one or more of autonomous vehicle(s) 10, 20, and/or 30. For example, such location(s) can include one or more locations for loading and/or unloading passengers of such vehicle(s), storing, refueling, recharging, or maintaining such vehicle(s), locating infrastructure supporting one or more non-automobile modes of transit (e.g., for transitioning between autonomous vehicles and such other transit modes, and/or the like) associated with such vehicle(s), and/or the like.

In some embodiments, the fleet configuration can be optimized, the location(s) can be determined to optimize the operation(s), function(s), and/or the like based at least in part on data indicated by the model(s), simulation(s), and/or the like. For example, such data can indicate number of units of travel traveled (e.g., measured in time, distance, and/or the like), cost incurred per unit of travel, revenue generated per unit of travel, profit generated per unit of travel, amount of commissioned travel, amount of non-commissioned travel, amount of autonomous-vehicle travel, amount of human-driven-vehicle travel, amount of non-automobile travel, amount of travel by passengers from origin-request locations to vehicle-loading locations, amount of travel by passengers from vehicle-unloading locations to passenger-specified destinations, time waited by passengers for vehicles to arrive, and/or the like.

At (330), based at least in part on the model(s), simulation(s), and/or the like, computing system 108 can generate data describing a report and can communicate such data to computing device 40, which can receive the data (e.g., for subsequent analysis, reconfiguration of the fleet, refinement of operational designs, logistics, and/or the like). For example, such a report can indicate one or more relationships (e.g., effects, dynamics, and/or the like) between operations, functions, and/or the like, within the geographic area, of autonomous vehicle(s) 10, 20, and/or 30, one or more human-driven vehicles included within the fleet, and/or the like. Additionally or alternatively, such a report can identify one or more of the determined location(s) with respect to the function(s) associated with autonomous vehicle(s) 10, 20, and/or 30.

At (332), based at least in part on the model(s), simulation(s), and/or the like, computing system 108 can generate data indicating instructions for autonomous vehicle 10 and can communicate such data to autonomous vehicle 10, which can receive the data. For example, such instructions can direct autonomous vehicle 10 to travel to a particular location in order to initiate new commissioned travel, station itself at a particular location to await further instructions (e.g., associated with new commissioned travel, and/or the like), travel to a particular location for maintenance, refueling, recharging, and/or the like, relocate to a different geographic area (e.g., with higher demand, a less saturated transit supply, more favorable weather conditions, and/or the like).

At (334), autonomous vehicle 10 can execute the instructions (e.g., autonomously navigate one or more portions of a travel route indicated by the instructions, and/or the like) and, at (336), can generate data describing travel completed by autonomous vehicle 10 (e.g., the portion(s) of the travel route, and/or the like) and can communicate such data to computing system 108, which can receive the data.

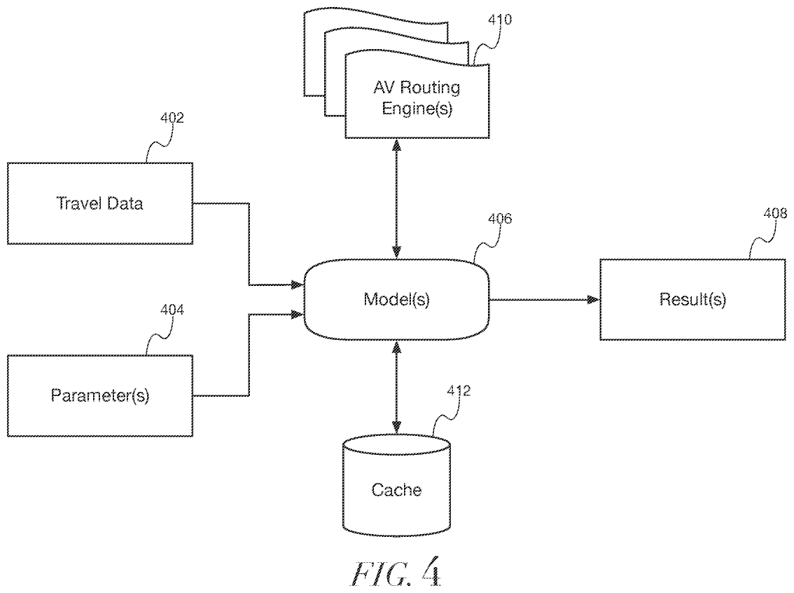

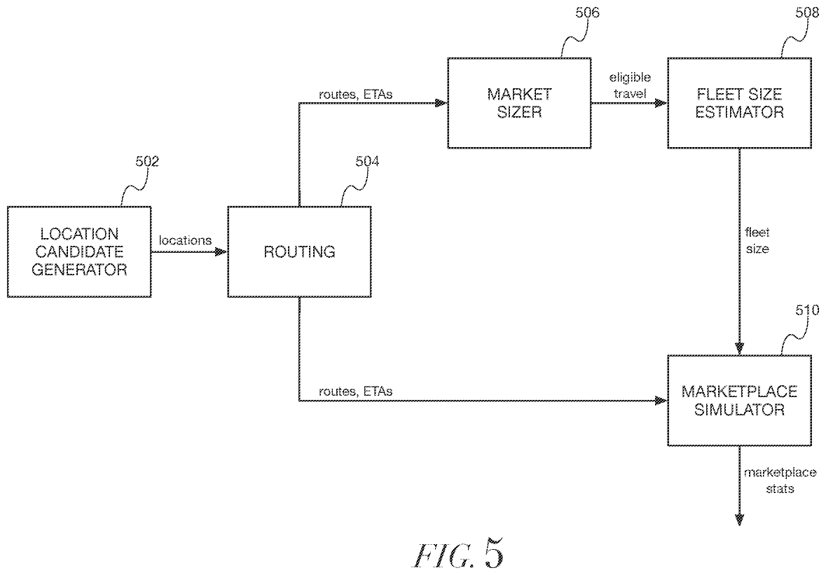

FIGS. 4 and 5 depict example system architectures according to example embodiments of the present disclosure.

Referring to FIG. 4, travel data 402 (e.g., describing travel completed by autonomous vehicle(s) 10, 20, and/or 30) and one or more parameters 404 (e.g., based at least in part on user input, and/or the like) can be provided. Based at least in part on travel data 402 and parameter(s) 404, one or more models 406 can be generated utilizing, for example, one or more autonomous-vehicle routing engines 410 (e.g., to determine one or more aspects of travel of autonomous vehicle(s) 10, 20, and/or 30 within the geographic area, and/or the like) and cache 412 (e.g., to store intermediary data, calculations, determinations, and/or the like). Based at least in part on model(s) 406, one or more results 408 can be determined (e.g., by performing one or more simulations of one or more operations, functions, and/or the like, within the geographic area, of one or more of autonomous vehicle(s) 10, 20, and/or 30).

Referring to FIG. 5, a computing system for performing one or more of the operations, functions, and/or the like described herein can include functionality and/or interface (e.g., directly, indirectly, and/or the like) with one or more other systems that include functionality for planning, modeling, simulating, and/or the like one or more aspects of the geographic area, the transportation market for the geographic area, and/or the like. For example, such systems can include functionality 502 for identifying locations within the geographic area for loading and/or unloading passengers, functionality 504 for determining possible routes navigable by autonomous vehicles, functionality 506 for estimating the available size of the transportation market for the geographic area, one or more aspects thereof, and/or the like, functionality 508 for estimating the size of a fleet of autonomous vehicles for servicing one or more aspects of such transportation market, and functionality 510 for modeling, simulating, and/or the like the market.

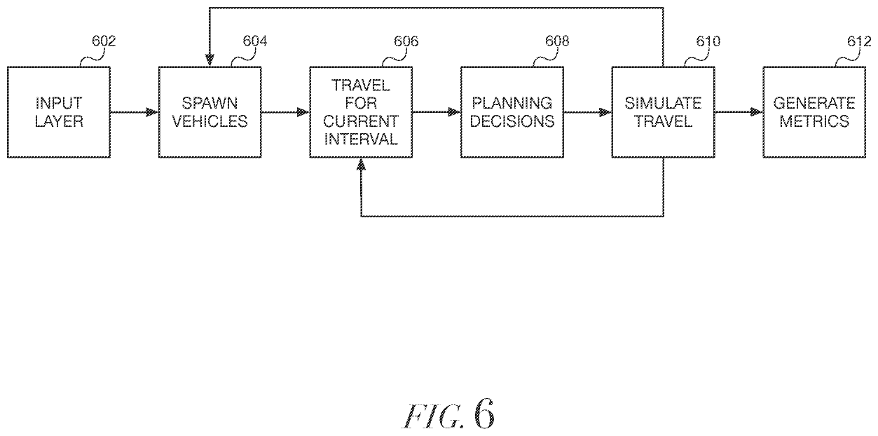

FIG. 6 depicts an example simulation flow according to example embodiments of the present disclosure.

Referring to FIG. 6, the simulation(s) can flow amongst various constituent components, including, for example, input layer 602, functionality 604 for spawning vehicle-simulation agents, functionality 606 for determining, identifying, and/or the like travel for a given interval of the simulation, functionality 608 for simulating one or more planning decisions, and/or the like, functionality 610 for simulating travel, and functionality 612 for generating one or more metrics about the geographic area, the transportation market for the geographic area, and/or the like. For example, input layer 602 could include receiving, determining, generating, and/or the like data indicating a date or date range for the simulation, a length of time (e.g., number of days, and/or the like) to be simulated, demand (e.g., describing various travel requests, and/or the like) for the simulation (e.g., based at least in part on the model(s), and/or the like), supply (e.g., availability of various vehicle types, configurations, and/or the like) for the simulation (e.g., based at least in part on the model(s), and/or the like), and/or supply dynamics (e.g., non-commissioned-travel behavior of various vehicle types, configurations, and/or the like) for the simulation (e.g., based at least in part on the model(s), and/or the like).

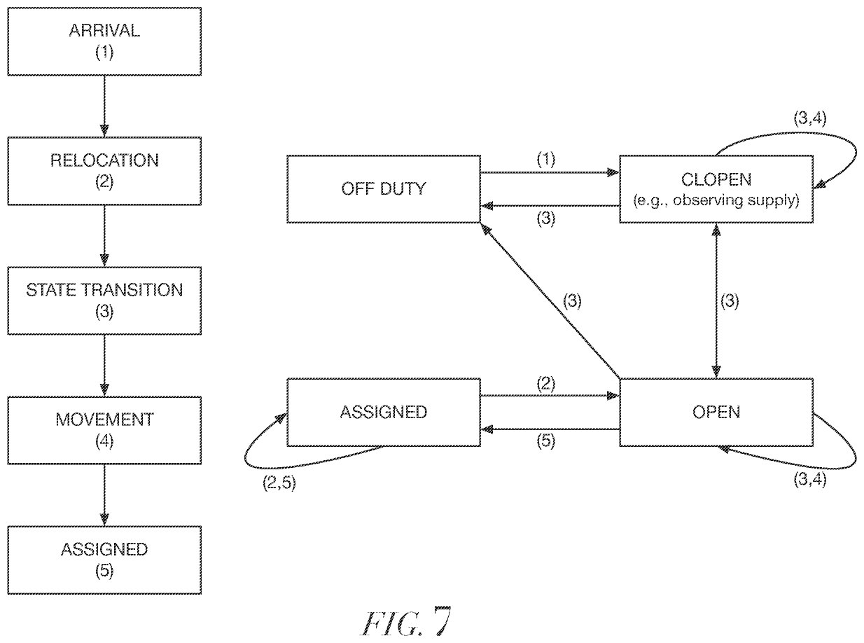

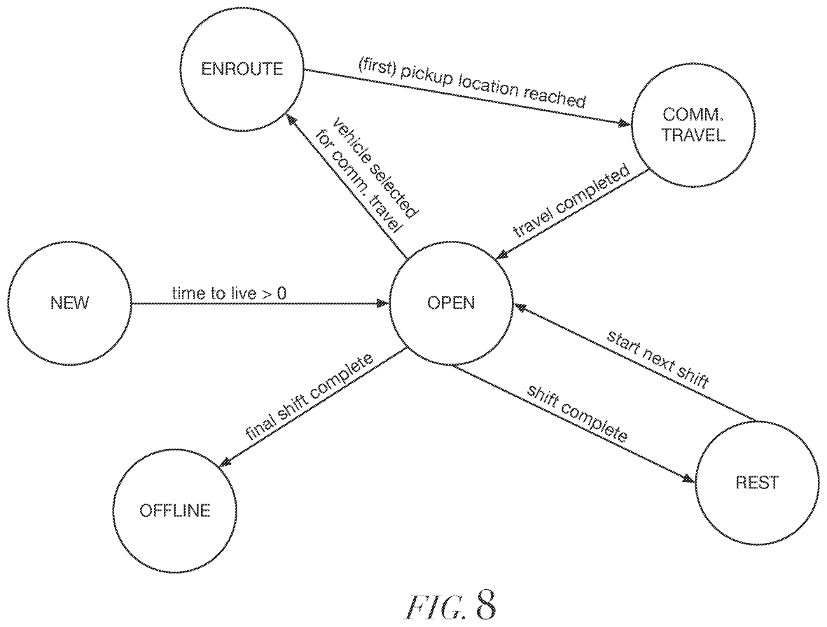

In some embodiments, for any given time, one or more of the vehicle(s) (e.g., the autonomous vehicle(s), human-driven vehicle(s), and/or the like) can be associated with one or more different vehicle states. For example, FIGS. 7 and 8 depict example states according to example embodiments of the present disclosure.

Such state(s) can include a state characterized by availability within the geographic area, a state characterized by commissioned movement within the geographic area, a state characterized by non-commissioned movement within the geographic area, a state characterized by planning commissioned travel, a state characterized by transitioning amongst one or more of the other states, and/or the like.

In some of such embodiments, generating the model(s) can include generating a different and distinct model for each of such vehicle state(s). For example, a model for the state characterized by availability within the geographic area could predict the number of vehicles operating within, entering, leaving, and/or the like the transportation market for the geographic area. Similarly, a model for the state characterized by commissioned movement within the geographic area can predict time spent on commissioned travel, routes utilized by such travel, and/or the like. While a model for the state characterized by non-commissioned movement within the geographic area can predict time utilized, distance traveled, and/or the like traveling from the conclusion of an instance of commissioned travel to initiation of a new instance of commissioned travel, and/or the like. A model for the state characterized by planning commissioned travel can predict the availability of vehicles for commissioned travel, and/or the like. And a model for the state characterized by transitioning amongst one or more of the other states can predict whether a vehicle will transition to a different state, what such state will be, when such transition will occur, and/or the like.

In some embodiments, for each time interval of a plurality of different time intervals within a time period for which the simulation(s) are configured to simulate the operation(s), function(s), and/or the like of the vehicle(s), computing system 108 can execute, for each vehicle of the vehicle(s) and each state of the different vehicle state(s), the model for the state in association with the vehicle for the time interval.

In some embodiments, the vehicle-simulation agents can function based at least in part on a discrete set of states and transitions amongst such states (e.g., a finite-state machine, and/or the like). Such agents can be configured to simulate various vehicle types, configurations, and/or the like, for example, autonomous vehicles, human-driven vehicles, and/or the like. For example, such agents can be associated with one or more shifts (e.g., based at least in part on historical logon/logoff times of its driver(s), and/or the like), can be spawned within the simulation at its logon location, re-spawned at its re-login location(s), track its spawn location(s), the time to its next shift, the time to the end of the current shift, and/or the like, and/or be configured to operate in accordance with certain parameters (e.g., complete commissioned travel, move or remain stationary between commissioned travel, govern travel in accordance with one or more geographic, speed, or performance constraints, and/or the like).

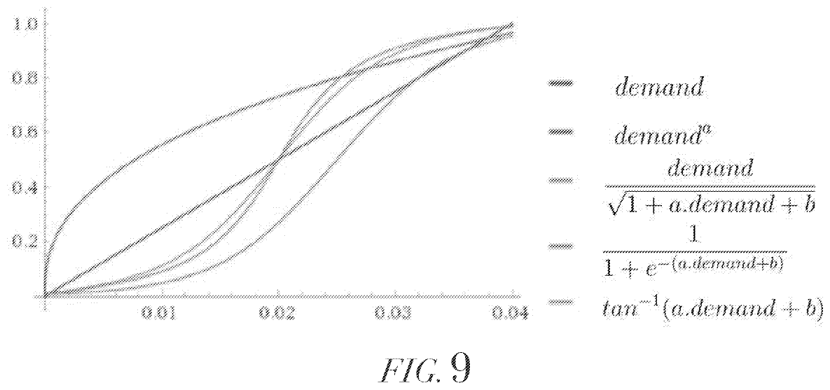

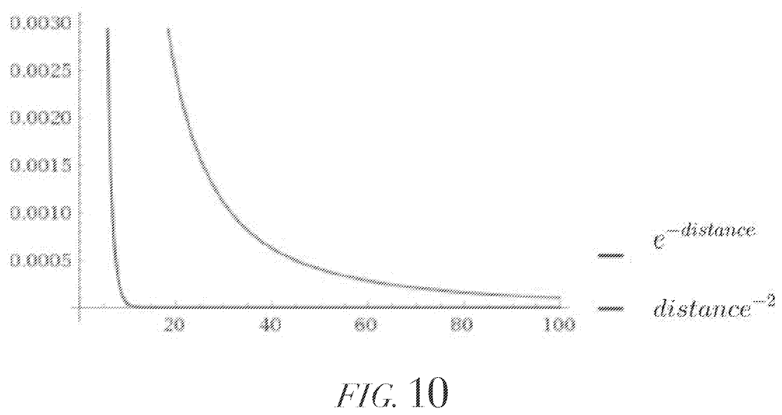

In some embodiments, supply dynamics can be simulated based at least in part on one or more different models. For example, FIGS. 9 and 10 depict example functional forms according to example embodiments of the present disclosure.

In some embodiments, such model(s) can include one or more demand-driven models, for example, under which vehicles relocate to areas with historic, anticipated, and/or the like demand when not commissioned, and/or the like. In some embodiments, such demand-driven model(s) can, for example, assign certain vehicles to remain stationary (e.g., based at least in part on a predetermined probability, and/or the like), while relocating other vehicles to areas determined based at least in part on a function of demand within the areas, distance to the areas from such vehicles' current locations, and/or the like. In some of such embodiments, the system can periodically re-determine whether a vehicle should remain stationary or relocate based on passage of a given amount of time without the vehicle being assigned commissioned travel, and/or the like. Additionally or alternatively, the model(s) can include one or more stationary models, for example, under which vehicles remain stationary when not commissioned, and/or the like. In some embodiments, such stationary model(s) can, for example, be utilized as default model(s), and/or the like. Additionally or alternatively, the model(s) can include one or more randomized models, for example, under which a random determination is made as to whether a vehicle remains stationary or relocates when not commissioned, and/or the like. In some embodiments, such randomized model(s) can, for example, assign certain vehicles to remain stationary (e.g., based at least in part on a predetermined probability, and/or the like), while relocating other vehicles to certain areas (e.g., the center of a randomly selected region from one or more identified regions surrounding a vehicle's current location, and/or the like), periodically re-determine whether a vehicle should remain stationary or relocate based on passage of a given amount of time without the vehicle being assigned commissioned travel, and/or the like.

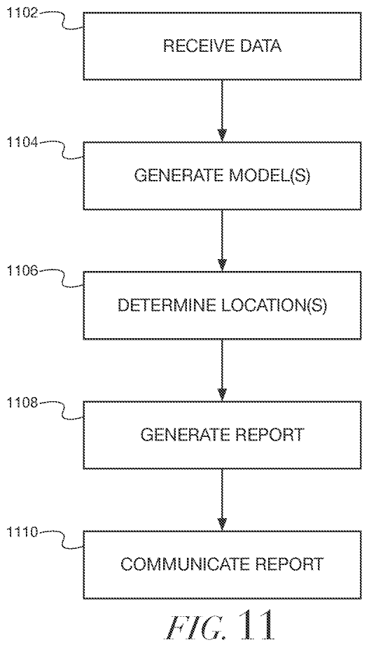

FIGS. 11-13 depict example methods according to example embodiments of the present disclosure.

Referring to FIG. 11, at (1102), one or more computing devices can receive, from a plurality of different autonomous vehicles, data describing travel completed by the plurality of different autonomous vehicles within a geographic area. For example, computing system 108 can receive, from autonomous vehicle(s) 10, 20, and/or 30, data describing travel completed by autonomous vehicle(s) 10, 20, and/or 30 within a geographic area.

At (1104), the computing device(s) can generate, based at least in part on the data describing the travel, one or more models indicating one or more effects of the plurality of different autonomous vehicles on a transportation market for the geographic area. For example, computing system 108 can generate, based at least in part on the data describing the travel completed by autonomous vehicle(s) 10, 20, and/or 30, one or more models indicating one or more effects of autonomous vehicle(s) 10, 20, and/or 30 on a transportation market for the geographic area.

At (1106), the computing device(s) can determine, based at least in part on the model(s), one or more locations in the geographic area for performing one or more functions associated with the plurality of different autonomous vehicles. For example, computing system 108 can determine, based at least in part on the model(s) indicating the effect(s) of autonomous vehicle(s) 10, 20, and/or 30 on the transportation market for the geographic area, one or more locations in the geographic area for performing one or more functions associated with autonomous vehicle(s) 10, 20, and/or 30.

At (1108), the computing device(s) can generate, based at least in part on the model(s), data describing a report identifying the location(s) with respect to the function(s) associated with the plurality of different autonomous vehicles. For example, computing system 108 can generate, based at least in part on the model(s) indicating the effect(s) of autonomous vehicle(s) 10, 20, and/or 30 on the transportation market for the geographic area, data describing a report identifying the location(s) with respect to the function(s) associated with autonomous vehicle(s) 10, 20, and/or 30.

At (1110), the computing device(s) can communicate the data describing the report identifying the location(s). For example, computing system 108 can communicate (e.g., to computing device 40, and/or the like), the data describing the report identifying the location(s) with respect to the function(s) associated with autonomous vehicle(s) 10, 20, and/or 30.

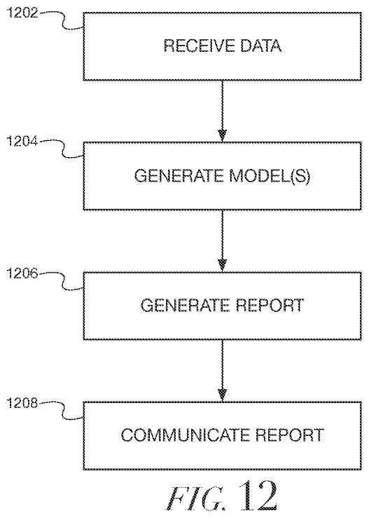

Referring to FIG. 12, at (1202), one or more computing devices can receive, from a plurality of different autonomous vehicles, data describing travel completed by the plurality of different autonomous vehicles within a geographic area. For example, computing system 108 can receive, from autonomous vehicle(s) 10, 20, and/or 30, data describing travel completed by autonomous vehicle(s) 10, 20, and/or 30 within a geographic area.

At (1204), the computing device(s) can generate, based at least in part on the data describing the travel, one or more models indicating one or more effects of the plurality of different autonomous vehicles on a transportation market for the geographic area. For example, computing system 108 can generate, based at least in part on the data describing the travel completed by autonomous vehicle(s) 10, 20, and/or 30, one or more models indicating one or more effects of autonomous vehicle(s) 10, 20, and/or 30 on a transportation market for the geographic area.

At (1206), the computing device(s) can generate, based at least in part on the model(s), data describing a report indicating one or more relationships between functions, within the geographic area, of the plurality of different autonomous vehicles and a plurality of different human-driven vehicles. For example, computing system 108 can generate, based at least in part on the model(s) indicating the effect(s) of autonomous vehicle(s) 10, 20, and/or 30 on the transportation market for the geographic area, data describing a report indicating one or more relationships between functions, within the geographic area, of autonomous vehicle(s) 10, 20, and/or 30 and a plurality of different human-driven vehicles.

At (1208), the computing device(s) can communicate the data describing the report indicating the relationship(s). For example, computing system 108 can communicate (e.g., to computing device 40, and/or the like), the data describing the report indicating the relationship(s).

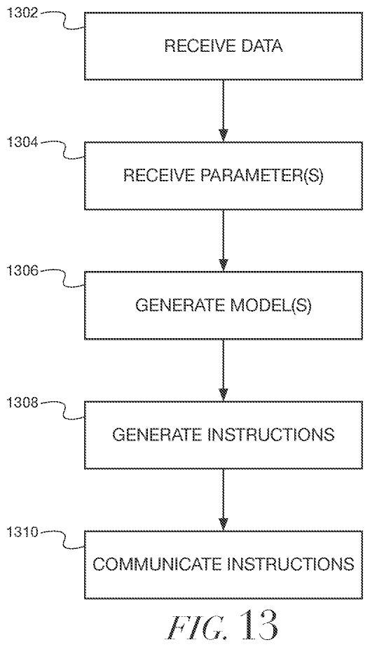

Referring to FIG. 13, at (1302), one or more computing devices can receive, from a plurality of different autonomous vehicles, data describing travel completed by the plurality of different autonomous vehicles within a geographic area. For example, computing system 108 can receive, from autonomous vehicle(s) 10, 20, and/or 30, data describing travel completed by autonomous vehicle(s) 10, 20, and/or 30 within a geographic area.

At (1304), one or more computing devices can receive, from a plurality of different autonomous vehicles, data indicating one or more model parameters for the geographic area. For example, computing system 108 can receive (e.g., from computing device 40, and/or the like) data indicating one or more parameters based at least in part on which one or more models indicating one or more effects of autonomous vehicle(s) 10, 20, and/or 30 on a transportation market for the geographic area can be generated.

At (1306), the computing device(s) can generate, based at least in part on the data describing the travel and the data indicating the parameter(s), one or more models indicating one or more effects of the plurality of different autonomous vehicles on a transportation market for the geographic area. For example, computing system 108 can generate, based at least in part on the data describing the travel completed by autonomous vehicle(s) 10, 20, and/or 30 and the data indicating the parameter(s), one or more models indicating one or more effects of autonomous vehicle(s) 10, 20, and/or 30 on a transportation market for the geographic area.

At (1308), the computing device(s) can generate, based at least in part on the model(s), data indicating instructions for at least one autonomous vehicle of the plurality of different autonomous vehicles. For example, computing system 108 can generate, based at least in part on the model(s) indicating the effect(s) of autonomous vehicle(s) 10, 20, and/or 30 on the transportation market for the geographic area, data indicating instructions for autonomous vehicle 10.

At (1310), the computing device(s) can communicate, to the at least one autonomous vehicle, the data indicating the instructions. For example, computing system 108 can communicate (e.g., to autonomous vehicle 10, and/or the like), the data indicating the instructions.

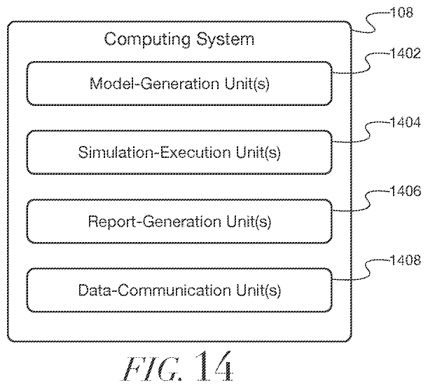

FIG. 14 depicts an example computing system according to example embodiments of the present disclosure.

Referring to FIG. 14, various means can be configured to perform the methods and processes described herein. For example, computing system 108 can include model-generation unit(s) 1402, simulation-execution unit(s) 1404, report-generation unit(s) 1406, data-communication unit(s) 1408, and/or other means for performing the operations and functions described herein. In some implementations, one or more of the units can be implemented separately. In some implementations, one or more units can be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry, for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means can be configured to generate the model(s), execute the simulation(s), determine the configuration(s), location(s), and/or the like, generate and/or communicate the data describing the report(s), and/or the like. In some implementations, the means can be configured to obtain (e.g., via an accessible memory) data, information, and/or the like (e.g., regarding the weather conditions, availability of vehicles, non-automobile modes of transportation, and/or the like) associated with the geographic area. A data-obtaining unit is one example of a means for obtaining such data as described herein.

The technology discussed herein refers to servers, databases, software applications, and/or other computer-based systems, as well as actions taken and information sent to and/or from such systems. The inherent flexibility of computer-based systems allows for a great variety of possible configurations, combinations, and/or divisions of tasks and/or functionality between and/or among components. For instance, processes discussed herein can be implemented using a single device or component and/or multiple devices or components working in combination. Databases and/or applications can be implemented on a single system and/or distributed across multiple systems. Distributed components can operate sequentially and/or in parallel.

Various connections between elements are discussed in the above description. These connections are general and, unless specified otherwise, can be direct and/or indirect, wired and/or wireless. In this respect, the specification is not intended to be limiting.

The depicted and/or described steps are merely illustrative and can be omitted, combined, and/or performed in an order other than that depicted and/or described; the numbering of depicted steps is merely for ease of reference and does not imply any particular ordering is necessary or preferred.

The functions and/or steps described herein can be embodied in computer-usable data and/or computer-executable instructions, executed by one or more computers and/or other devices to perform one or more functions described herein. Generally, such data and/or instructions include routines, programs, objects, components, data structures, or the like that perform particular tasks and/or implement particular data types when executed by one or more processors in a computer and/or other data-processing device. The computer-executable instructions can be stored on a computer-readable medium such as a hard disk, optical disk, removable storage media, solid-state memory, read-only memory (ROM), random-access memory (RAM), and/or the like. As will be appreciated, the functionality of such instructions can be combined and/or distributed as desired. In addition, the functionality can be embodied in whole or in part in firmware and/or hardware equivalents, such as integrated circuits, application-specific integrated circuits (ASICs), field-programmable gate arrays (FPGAs), and/or the like. Particular data structures can be used to more effectively implement one or more aspects of the disclosure, and such data structures are contemplated to be within the scope of computer-executable instructions and/or computer-usable data described herein.

Although not required, one of ordinary skill in the art will appreciate that various aspects described herein can be embodied as a method, system, apparatus, and/or one or more computer-readable media storing computer-executable instructions. Accordingly, aspects can take the form of an entirely hardware embodiment, an entirely software embodiment, an entirely firmware embodiment, and/or an embodiment combining software, hardware, and/or firmware aspects in any combination.

As described herein, the various methods and acts can be operative across one or more computing devices and/or networks. The functionality can be distributed in any manner or can be located in a single computing device (e.g., server, client computer, user device, and/or the like).

Aspects of the disclosure have been described in terms of illustrative embodiments thereof. Numerous other embodiments, modifications, and/or variations within the scope and spirit of the appended claims can occur to persons of ordinary skill in the art from a review of this disclosure. Any and all features in the following claims can be combined and/or rearranged in any way possible.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and/or equivalents to such embodiments. Accordingly, the subject disclosure does not preclude inclusion of such modifications, variations, and/or additions to the present subject matter as would be readily apparent to one of ordinary skill in the art. For instance, features illustrated and/or described as part of one embodiment can be used with another embodiment to yield a still further embodiment. Thus, it is intended that the present disclosure cover such alterations, variations, and/or equivalents.

What is claimed is:

1. A computer-implemented method comprising:
receiving, by one or more computing devices and from a plurality of different autonomous vehicles, data describing travel completed by the plurality of different autonomous vehicles within a geographic area;
receiving, by the one or more computing devices, data indicating one or more model parameters for the geographic area;
generating, by the one or more computing devices and based at least in part on the data describing the travel and the data indicating the one or more model parameters, one or more models indicating one or more effects of the plurality of different autonomous vehicles on a transportation market for the geographic area;
generating, by the one or more computing devices and based at least in part on the one or more models, data indicating instructions for at least one autonomous vehicle of the plurality of different autonomous vehicles; and
communicating, by the one or more computing devices and to the at least one autonomous vehicle, the data indicating the instructions for the at least one autonomous vehicle.

2. The computer-implemented method of claim 1, wherein:
receiving the data indicating the one or more model parameters comprises receiving data indicating one or more weather conditions for the geographic area; and
generating the one or more models comprises generating the one or more models based at least in part on the data indicating the one or more weather conditions.

3. The computer-implemented method of claim 1, wherein:
receiving the data indicating the one or more model parameters comprises receiving data indicating one or more capabilities of one or more autonomous vehicles configurable to operate within the geographic area; and
generating the one or more models comprises generating the one or more models based at least in part on the data indicating the one or more capabilities of the one or more autonomous vehicles.

4. The computer-implemented method of claim 1, wherein:
receiving the data indicating the one or more model parameters comprises receiving data indicating one or more of a date, time, time of day, day of week, week of month, or month of year; and
generating the one or more models comprises generating the one or more models based at least in part on the data indicating the one or more of the date, time, time of day, day of week, week of month, or month of year.

5. The computer-implemented method of claim 1, wherein:
the method comprises receiving, by the one or more computing devices, data indicating availability of one or more autonomous vehicles configurable to operate within the geographic area; and
generating the one or more models comprises generating the one or more models based at least in part on the data indicating the availability of the one or more autonomous vehicles.

6. The computer-implemented method of claim 5, wherein:
the plurality of different autonomous vehicles is associated with a first provider of autonomous vehicles;
the one or more autonomous vehicles are associated with a second provider of autonomous vehicles;
the first provider is different and distinct from the second provider;
the method comprises providing, by the one or more computing devices and to a computing system associated with the second provider, an application programming interface (API); and
receiving the data indicating the availability comprises receiving the data indicating the availability from the computing system associated with the second provider via the API.

7. The computer-implemented method of claim 1, wherein:
the method comprises receiving, by the one or more computing devices, data indicating one or more of a capability or availability of a non-automobile mode of transit configurable to operate within the geographic area; and
generating the one or more models comprises generating the one or more models based at least in part on the data indicating the one or more of the capability or availability of the non-automobile mode of transit.

8. A system comprising:
one or more processors; and
a memory storing instructions that when executed by the one or more processors cause the system to perform operations comprising:
receiving, from a plurality of different autonomous vehicles, data describing travel completed by the plurality of different autonomous vehicles within a geographic area;
generating, based at least in part on the data describing the travel completed by the plurality of different autonomous vehicles and data describing travel completed by a plurality of different human-driven vehicles within the geographic area, one or more models indicating one or more effects of the plurality of different autonomous vehicles on a transportation market for the geographic area;
generating, based at least in part on the one or more models, data describing a report indicating one or more relationships between functions, within the geographic area, of the plurality of different autonomous vehicles and the plurality of different human-driven vehicles; and
communicating, to a computing device, the data describing the report indicating the one or more relationships.

9. The system of claim 8, wherein generating the one or more models comprises generating, for each state of a plurality of different vehicle states, a different and distinct model for the state.

10. The system of claim 9, wherein the plurality of different vehicle states comprises:
a state characterized by availability within the geographic area;
a state characterized by commissioned movement within the geographic area; and
a state characterized by non-commissioned movement within the geographic area.

11. The system of claim 9, wherein:
the operations comprise executing, based at least in part on the one or more models, one or more simulations of functions, within the transportation market for the geographic area, of the plurality of different autonomous vehicles; and
generating the data describing the report comprises generating the data describing the report based at least in part on the one or more simulations.

12. The system of claim 11, wherein executing the one or more simulations comprises, for each time interval of a plurality of different time intervals within a time period for which the one or more simulations are configured to simulate the functions of the plurality of different autonomous vehicles, executing, for each:
vehicle of the plurality of different autonomous vehicles and the plurality of different human-driven vehicles, and
each state of the plurality of different vehicle states,
the different and distinct model for the state in association with the vehicle for the time interval.

13. The system of claim 8, wherein the operations comprise determining, based at least in part on the one or more models, a configuration for a fleet of autonomous vehicles comprising the plurality of different autonomous vehicles.

14. The system of claim 13, wherein determining the configuration for the fleet comprises optimizing the configuration for the fleet based at least in part on one or more of:
number of units of travel traveled;
cost incurred per unit of travel;
revenue generated per unit of travel;
profit generated per unit of travel;
amount of commissioned travel;
amount of non-commissioned travel;
amount of autonomous-vehicle travel;
amount of human-driven-vehicle travel;
amount of non-automobile travel;
amount of travel by passengers from origin-request locations to vehicle-loading locations;
amount of travel by passengers from vehicle-unloading locations to passenger-specified destinations; or
time waited by passengers for vehicles to arrive.

15. One or more non-transitory computer-readable media comprising instructions that when executed by one or more computing devices cause the one or more computing devices to perform operations comprising:
receiving data describing travel completed by a fleet of associated vehicles within a geographic area;
generating, based at least in part on the data describing the travel, one or more models indicating one or more effects of a plurality of different autonomous vehicles on a transportation market for the geographic area;
determining, based at least in part on the one or more models, one or more locations in the geographic area for performing one or more functions associated with the plurality of different autonomous vehicles;
generating, based at least in part on the one or more models, data describing a report identifying the one or more locations with respect to the one or more functions associated with the plurality of different autonomous vehicles; and
communicating, to a computing device, the data describing the report identifying the one or more locations.

16. The one or more non-transitory computer-readable media of claim 15, wherein determining the one or more locations comprises determining one or more locations for one or more of loading or unloading passengers of one or more of the plurality of different autonomous vehicles.

17. The one or more non-transitory computer-readable media of claim 15, wherein determining the one or more locations comprises determining one or more locations for one or more of storing, refueling, recharging, or maintaining one or more of the plurality of different autonomous vehicles.

18. The one or more non-transitory computer-readable media of claim 15, wherein determining the one or more locations comprises determining one or more locations for locating infrastructure supporting a non-automobile mode of transit associated with one or more of the plurality of different autonomous vehicles.

19. The one or more non-transitory computer-readable media of claim 15, wherein determining the one or more locations comprises identifying, from amongst a plurality of different locations, the one or more locations based at least in part on a determination that the one or more locations optimize at least one of the one or more functions.

20. The one or more non-transitory computer-readable media of claim 19, wherein the determination that the one or more locations optimize the at least one of the one or more functions is based at least in part on one or more of:
number of units of travel traveled;
cost incurred per unit of travel;
revenue generated per unit of travel;
profit generated per unit of travel;
amount of commissioned travel;
amount of non-commissioned travel;
amount of autonomous-vehicle travel;
amount of human-driven-vehicle travel;
amount of non-automobile travel;
amount of travel by passengers from origin-request locations to vehicle-loading locations;
amount of travel by passengers from vehicle-unloading locations to passenger-specified destinations; or
time waited by passengers for vehicles to arrive.
